(19) United States
(12) Patent Application Publication
(10) Pub. No.: US 2022/0270116 A1
(43) Pub. Date: Aug. 25, 2022

(54) Methods to identify critical customer experience incidents using remotely captured eye-tracking recording combined with automatic facial emotion detection via mobile phone or webcams.

(71) Applicants: Neil Fleischer, Montreal (CA); Francois Courtemanche, Montreal (CA); Pierre-Majorique Leger, Montreal (CA); Sylvain Senecal, Carignan (CA); Marc Fredette, Candiac (CA)

(72) Inventors: Neil Fleischer, Montreal (CA); Francois Courtemanche, Montreal (CA); Pierre-Majorique Leger, Montreal (CA); Sylvain Senecal, Carignan (CA); Marc Fredette, Candiac (CA)

(21) Appl. No.: 17/672,012

(22) Filed: Feb. 15, 2022

Related U.S. Application Data
(60) Provisional application No. 63/153,008, filed on Feb. 24, 2021.

(51) Int. Cl. G06Q 30/02; G06V 20/40; G06V 40/16; G06V 40/18

(52) U.S. Cl. CPC G06Q 30/0201; G06V 20/40; G06V 40/174; G06V 40/18

(57) ABSTRACT

Systems and methods are provided by analyzing video responses to human interactions with computers or screens for web-journey and marketing optimization purposes. The video feed of the participants face is then used to develop individual insights into, individual responses associated with eye-movement (speed, distance travelled over time, saccades, fixation, blinks), and facial emotions (happy, surprised, sad, fear, anger, disgust, and neutral). Our system then combines these individual metrics, through our proprietary algorithm, into a single output that combines the individual insights (eyes and facial emotion), and then creates a more valuable insight through the compounding effect of the metrics.

### BACKGROUND OF THE INVENTION

Increasingly, companies' online interfaces (websites and apps) are becoming more important to their revenue and profit streams. As such, we see a shift in company strategy, away from traditional brick and mortar stores, towards servicing their clients online through websites and apps. Unlike traditional store journeys where you can engage 1 on 1 with your shopper, today, the need to identify trends in the online shopping experience is crucial.

Accordingly, there is a need to be able to identify points along a consumer's online journey that either create points of attachment or abandonment to their online visit and overall long-term relationship with the company.

### BRIEF SUMMARY OF THE INVENTION

This invention is based upon the ideal of multi-modal data capturing in order to identify points of interest along a computer human interaction journey. This invention focuses on the accessing of computer and mobile phones webcams (through user consent) and captures high resolution video of the person face.

Capturing this video, allows for the tool to identify, on their own merits, 1. The emotions of the user by analyzing hundreds of points along the person face in order to ascertain their emotions associate with the event. 2. The movement of the person eye's through remotely generated eye-tracking allowing for the understanding of important visual tracking clues along the person' journey. While on their own, these metrics have value towards assessing someone experience, our invention combines these measures together, into a single unique moment that compounds the findings of individuals into a stronger more predictive understanding of the moment.

### DESCRIPTION OF DRAWINGS

FIG. 1. Shows the unimodal data stream captured during the process of a research into an individual's experience.

FIG. 2. Is a visual representation of the formula used to determine the invention and how to process the end data sets.

FIG. 3. Shows and describes the circumplex model that has been developed through the process of combining the multi-modal approach this invention is asserting.

### DETAILED DESCRIPTION OF THE INVENTION

Understanding how a person is reacting towards a moment is crucial to creating better experiences and gathering more meaningful insights into how the respondent was impacted by the event. A person is not able to tell you how they feel about something without personal bias' coming into play, rendering their version of the events, rather loose and inconsequential.

Consumer research, in the past has almost exclusively relied on System 2 (the mind's slower, analytical mode, where reason dominates) to identify how a customer is truly feeling towards a brand and it's delivered experiences. Over the years, science has proven that people cannot accurately give insights into their experiences without many mitigating factors emerging, rendering the data received from the person lacking the validity to ensure positive insights derived.

Over time, as the technology viability grew, along with progression in research and understanding of System 1 (our faster, automatic, intuitive, and emotional mode of thinking), the validity and ability to track System 1 in consumer behavior has grown and become a valuable component towards identifying insights into consumer experience. Two of the most widely used technologies to identify System 1 responses in consumer behavior have been driven by the growth in eye-tracking and facial emotion detection.

### DESCRIPTION OF THE PRIOR ART

### Eye-Tracking:

Having been around since the early 1900's eye-tracking has become an important way to identify paths along a consumer journey and interaction. Normally done in-labs, due to the complexity of the equipment and need for proper conditions, eye-tracking, on it's own can deliver insights that allow for researchers to identify trends in experiences.

### Emotional Response:

By analyzing micro-movements in people's faces, science has been able to identify a set of basic emotions that are being felt by a participant. Cheek movement, eye-brows, forehead and other parts of the face are analyzed during this interaction. The output is insights into how a person; emotions are actually being effected by a given event.

The disclosure herein is an improvement to the status quo of using unimodal biometric responses, such as eye-tracking or facial emotion to gain an insight into a person reaction to an event. Our solution proposes to combine remotely captured eye-tracking and facial emotion data, and use the combining time response to identify when an abnormal occurrence is happening. An abnormal occurrence would be that where both, uniquely captured biometric response are showing an upper percentile (example upper 75^{th} percentile) or lower percentile (example lower 10^{th} percentile) of output at the same time. Allowing for an understanding and insights into that moment to be based upon both facial emotions and eye-tracking data rather than them alone.

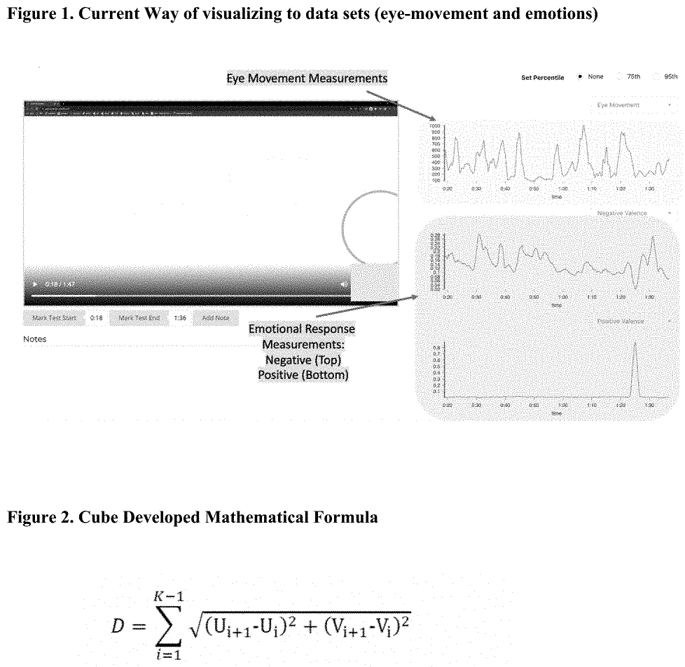

FIG. 1. Is a visualization into how when analyzing someone journey, we can identify the unimodal reception of facial emotion and eye-tracking. It represents one person journey on a website (can be done either on desktop or mobile). Our invention is to improve upon this methodology by generating a way of combining these metrics together and providing an insight based on the formula in FIG. 2.

FIG. 2. We have developed a mathematical formula that will combine the individual data sets and combine them to represent an insight that can compound the benefits independent variables into a single moment that represents a stronger indication in the persons moment along their journey.

For each epoch of one second (to validate empirically by Cube, based on the sampling frequency—Hertz—to ensure that enough data points are available for each epoch), we propose to calculate total gaze distance during that epoch (distance), as well as the average emotional valence. This distance is simply the sum of the Euclidean distances between each data point within the epoch. For example, if there are K data points in one epoch each at coordinates (Ui,Vi), i=1, . . . K then the total distance is given by the calculation

Building on previous literature, we hypothesize that distance is a psychophysiological inference of the user's hesitation in a given interaction. The more the distance, the more the participant has hesitated to perform the interaction (e.g., not sure how what to focus on to complete a task, looking for specific information).

This calculation will lead to x number of epochs for every participant. For example, for a given participant, a recording of 60 seconds will lead to 60 data coordinates of distance and valence to be plotted.

Given a data collection of n number of participants, the dataset will allow to identify moments of interaction that deviate from the ideal experience:
High moment of hesitation (distance) with low valence
High moment of hesitation (distance) with high valence
Low moment of hesitation (distance) with low valence
Low moment of hesitation (distance) with high valence.

Based on our experience, the insight can be classified in the following categories:
Elements of interface design
Problem with navigation
Unexpected behavior of the interface
Problem with selection
Problem with input
Problem with reading content.

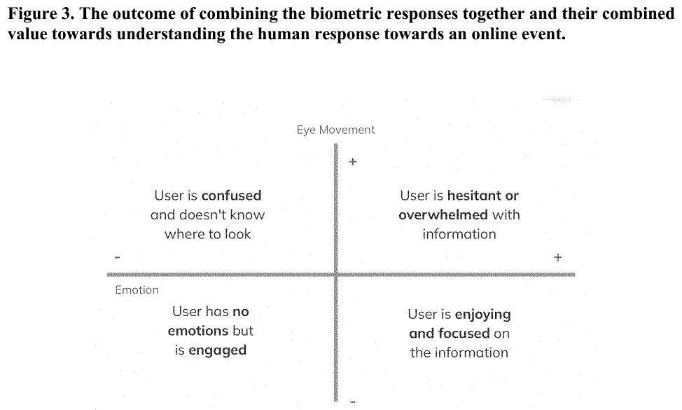

FIG. 3. Represents the visual display of the insight into the person(s) experience represented in a circumplex of biometric responses.
On the top left, with negative valence and high distance, users are frustrated and wondering where to look.
On the top right, with high valence and high distance, users are hesitating among choices that they like; it could be in a product grid in which you are hesitating among several interesting products.
On the low right, with high valence and low distance, users are enjoying what they see and they have long fixations on close stimuli.
On the bottom left, with low distance and low valence, users are not unhappy but engaged. For example, it could be when ready a user term conditions line by line.

1. A system and method to identify critical moments along a person' interaction with a website, app, and/or media, that can identify points along that journey that are of interests to understanding the person' overall response (example enjoyment or frustration towards) the event;
By combining eye-tracking data and facial emotion data, we can derive a richer insight and thus deeper understanding of the individuals reaction towards the interaction that can help companies create better experiences and marketing tools for their customer's.
